(19) United States
(12) Patent Application Publication
(10) Pub. No.: US 2016/0360737 A1
(43) Pub. Date: Dec. 15, 2016

(54) FIELD RECONFIGURABLE FISHING LURE

(71) Applicants: William M. YATES, Aliso Viejo, CA (US); James Durwood SUMMERS, Costa Mesa, CA (US)

(72) Inventors: William M. YATES, Aliso Viejo, CA (US); James Durwood SUMMERS, Costa Mesa, CA (US)

(21) Appl. No.: 15/173,591

(22) Filed: Jun. 3, 2016

Related U.S. Application Data
(60) Provisional application No. 62/173,001, filed on Jun. 9, 2015.

(51) Int. Cl. A01K 85/18

(52) U.S. Cl. CPC A01K 85/18

(57) ABSTRACT

A field reconfigurable fishing lure having an adjustable buoyancy mechanism, an adjustable tail mechanism and modular accessory rail system.

### BACKGROUND OF THE INVENTION

This application claims the benefit of U.S. Provisional Application No. 62/173,001, filed on Jun. 9, 2015, the contents of which are incorporated herein by reference.

### FIELD OF THE INVENTION

The present invention relates to the field of fishing lures and more particularly to a novel fishing system having a design which allows a user to quickly and easily reconfigure the performance of the fishing lure while in the field.

### DISCUSSION OF THE RELATED ART

The sport of fishing is gaining popularity, especially in the field of bass fishing, where a large variety of lures are available to the fisherman, each with different performance characteristics specifically tuned by the manufacturer of such lures to a specific element or situation that may be encountered while fishing.

The wide variety of situations a fisherman may find himself in while fishing has stimulated the manufacturers of fishing lures to respond by offering an ever-widening variety of fishing lures in the marketplace. The often conflicting claims and strategies suggested by the manufacturers in the use of such lures has not only confused the fisherman, but has also compelled him to purchase a large selection of fishing lures at great expense. In some cases, bass fishing lures sell for figures of between $250-$500 each, and the successful marketing of these lures has resulted in low inventory levels, backorders and long wait times for production.

Three of the most popular bass fishing lure functions found in the state-of-the-art lures are (1) gliding, (2) waking, and (3) shuddering, and no single lure can provide all of these functions in a reconfigurable and customizable system.

A glide bait fishing lure is preconfigured by the manufacturer to slowly sink after casting, with a slightly nose-down attitude (aka pitch attitude) and then to smoothly glide back and forth while being reeled in by the fisherman by way of a hinge connecting the head to the tail that provides a pivoting action.

A wake bait fishing lure also has a hinge, but with less angular freedom and therefore less pivoting action than the glide bait, and is preconfigured by the manufacturer to float on or near the surface of the water after casting, and to leave a wake on the surface while being reeled in and additionally to dive under water due to a feature known as a “wake bill” or “diving plate”, which causes submersion due to water pressure acting on it to sink or partially sink the lure while being reeled in by the fisherman.

A shudder tail fishing lure features a rigid or semi-rigid body, usually with no hinge, and prominently features a hard or soft tail portion that has a reduced thickness at the point where it joins the fishing lure body and a large, bulbous rear tail portion that is preconfigured by the manufacturer to pendulum back and forth to create a realistic swimming motion while being reeled in by the fisherman.

All three of the aforementioned fishing lures have enjoyed widespread sales success, at the expense of fishermen, who believe they need to purchase numerous fishing lures in order to have a “complete set” with varying functionality that may be desirable while out in the field practicing the sport of fishing.

In some cases, the difference between the functionalities of the various popular fishing lures can be accomplished by changing a tail or adding or removing weight or material in the right amount and location. A number of hobbyists have discovered how to alter such fishing lures by grinding away portions of the body, removing lead weights that were intended by the manufacturer to be permanent, and other such aftermarket modifications and alterations. Mostly such alterations result in the permanent loss of the original design function, since the grinding, drilling and other invasive procedures used by the hobbyist to change the function of the fishing lure cannot easily be undone.

Manufacturers have attempted to make their products adjustable to themselves during the manufacturing process in order to serve a variety of markets with a single lure design platform, but none have succeeded in inventing a way to allow easy adjustment and reconfiguration by the fisherman in the field. Huddleston discloses an adjustable rate of fall (“ROF”) by use of a weighted insert in U.S. Pat. No. 7,743,550 and U.S. Pat. No. 7,627,979 but provides no structure, means or disclosure for a fisherman to make such an adjustment, rather, it is intended that the manufacturer selects a weighted insert and corresponding ROF at the time of manufacturing, resulting in a lure with permanent and nonadjustable ROF performance characteristics being sold to the end user. Rate of fall is defined in the fishing industry as the depth to which the fishing lure sinks in 10 seconds.

The above mentioned '550 and '979 patents also disclose a vortex-generating shudder tail but again provide no structure, means or disclosure for a fisherman to make an adjustment to, or remove the permanently installed tail, which is an integral part of the entire lure.

Huddleston's U.S. Pat. No. 5,815,978 discloses the use of a wake bill, or “diving plate”, which is “fixedly secured to the underside of the rigid head”. There is no structure, means or disclosure for a fisherman to make an adjustment to, or remove the permanently installed wake bill or to change it out with a second wake bill of differing shape or design in order to customize the diving characteristics.

Yet another patent of Huddleston, U.S. Pat. No. 6,212,818 discloses a fishing lure with an internal “capsule” containing a plurality of metal balls, but the stated purpose of the capsule and balls is to allow the balls to strike one another in order to make a rattle sound that purportedly attracts fish. The balls are inserted into the capsule at the time of manufacture and are neither accessible nor adjustable by the fisherman and are therefore of no use in altering the buoyancy or ROF characteristics of the lure.

Manufacturers other than Huddleston are producing swim bait fishing lures with individual features such as a company in Japan named DEPS. Among other products, DEPS produces three separate fishing lures, with each lure having one of the aforementioned non-adjustable features: (1) gliding, (2) waking, and (3) shuddering functionality respectively. The DEPS “Slide Swimmer” is a glide bait, the DEPS “Silent Killer” is a wake bait, and the DEPS “Slide Swimmer Shudder Tail” is a shudder tail bait. If a fisherman desires these functionalities in his inventory of fishing lures, he must purchase all three products individually from a DEPS dealer at great expense.

With the above problems in mind, it is needed a more efficient and cost effective method of providing a fisherman with a fishing lure that can easily be reconfigured with different important functions and performance levels while in the field, including (1) gliding, (2) waking, and (3) shuddering in a single lure, without compromising, altering or permanently affecting any of the original design features of the fishing lure.

### SUMMARY OF THE INVENTION

Accordingly, the present invention is directed to a field reconfigurable fishing lure system that is cost effective and reconfigurable by the fisherman to perform all of the popular functions of state-of-the-art, single-function fishing lures.

An advantage of the present invention is to provide a cost effective fishing lure that is reconfigurable by the fisherman to perform as a glide bait.

Another advantage of the present invention is to provide a cost effective fishing lure that is reconfigurable by the fisherman to perform as a wake bait.

Still another advantage of the present invention is to provide a cost effective fishing lure that is reconfigurable by the fisherman to perform as a shudder tail bait.

Still another advantage of the present invention is to provide a cost effective fishing lure that is reconfigurable by the fisherman to either float on the surface or to sink at a wide variety of different sink rates (aka “rates of fall” or “ROF”) and at a wide variety of nose-up or nose-down pitch attitudes.

Still another advantage of the present invention is to provide a cost effective fishing lure that is reconfigurable by the fisherman to variations of buoyancy, weight and balance, and other parameters in combinations and permutations based on their own imagination and personal experience.

Still another advantage of the present invention is to provide a cost effective fishing lure with a hinged tail that is reconfigurable by the fisherman to pivot through a variety of angles or to be locked out so that no pivoting of the fish tail occurs at all.

Still another advantage of the present invention is to provide a cost effective fishing lure with a modular rail system allowing different attachments, devices, and mechanisms to be slideably attached to the bottom of the fishing lure.

Still another advantage of the present invention is to provide a cost effective fishing lure that has modular components that can easily be replaced if lost or broken to ensure the fisherman can enjoy the benefits of the fishing lure for many years.

Still another advantage of the present invention is to provide a cost effective fishing lure that can easily be mass produced in order to eliminate the problem of poor inventory readiness, long wait times, backorders and artificially high retail prices that has plagued the swim bait industry.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a field reconfigurable fishing lure; an adjustable buoyancy mechanism, an adjustable tail mechanism and modular rail system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is view of the prior art “DEPS Slide Swimmer” fishing lure.

FIG. 2 is a side cutaway view of an embodiment of the fishing lure of the present invention.

FIG. 3 is an exploded side view showing how a fisherman can easily gain access to the internal buoyancy chambers.

FIG. 4 is a rear perspective view of the buoyancy chambers with integrated lower rail system and provisions for tail pivot stop pins.

FIG. 5 is a front perspective view of the buoyancy chambers with integrated lower rail system and provisions for front eye hook.

FIG. 6 is a perspective view of two configurations of user installable wake bills with different angles for tuning performance.

FIG. 7 is a perspective view of a hook attach fin that slideably engages the lower rail system.

FIG. 8 is a perspective view of the plugs that matably seal the ends of the buoyancy chambers while providing tabs for the tail pivot hinge mechanism.

FIG. 9 is a perspective view of the pivoting tail of the fishing lure with grooves to receive the hinge tabs from the plugs of FIG. 8.

FIG. 10 is a perspective view of a non-shudder tail,which slideably engages the tail of FIG. 9 and is user changeable.

FIG. 11 is a perspective view of a shudder tail, which slideably engages the tail of FIG. 9 and is user changeable.

FIG. 12 is a top view of the fishing lure of the present invention showing the non-shudder tail and hinge mechanism.

FIG. 13 is a top view of the fishing lure of the present invention showing the non-shudder tail and hinge mechanism at various pivot angles as determined by the insertion and removal of stop pins by the user.

FIG. 14 is a perspective view of exemplary types of ballast.

FIG. 15 is an assembly view of a working prototype of the fishing lure of the present invention showing the optionally partially concealed lower rail system.

FIG. 16 is a perspective view of a working prototype of the fishing lure of the present invention showing the field disassembly of the head and tail portions.

FIG. 17 is a perspective view of the underside of a working prototype of the fishing lure of the present invention showing the optionally exposed lower rail system.

FIG. 18 is a perspective view of two alternate embodiments of the lower rail system.

### DETAILED DESCRIPTION OF THE ILLUSTRATED EMBODIMENTS

Reference will now be made in detail to an embodiment of the present invention, example of which is illustrated in the accompanying drawings.

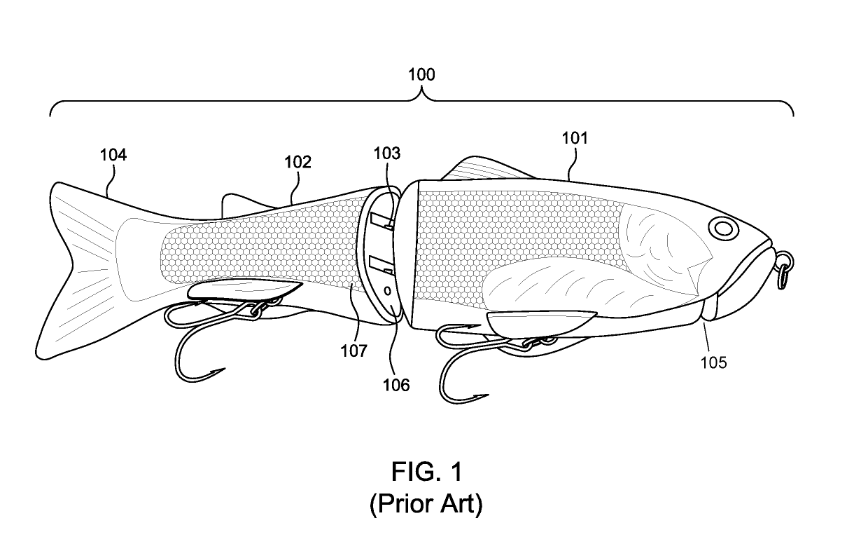

A side view of the DEPS “Slide Swimmer” prior art swim bait is illustrated in FIG. 1. Exemplary prior art fishing lures typically include a head portion 101, a tail portion 102 and a hinge 103 connecting the head to the tail and allowing a lateral pivoting motion that simulates the movement of a fish. The head contains a wake bill notch 105 on the underside of the chin to enable the manufacturer to use the same mold or production tooling to produce a second version of the product having the wake bill feature. The wake bill notch of the DEPS “Slide Swimmer” does not allow a fisherman to install a wake bill into the “Slide Swimmer” product; rather, the user must purchase a second DEPS product called the “Silent Killer” in order to benefit from the wake bill feature, which even in the “Silent Killer” version, is not removable, replaceable or adjustable but is permanently glued into place. Additionally, the DEPS “Slide Swimmer” of FIG. 1 is constructed with a casting resin body 106 covered by a plastic Poly Vinyl Chloride (PVC) skin 107. A new DEPS product of the same name and design is now being sold and is manufactured by injection molding techniques rather than by casting resin.

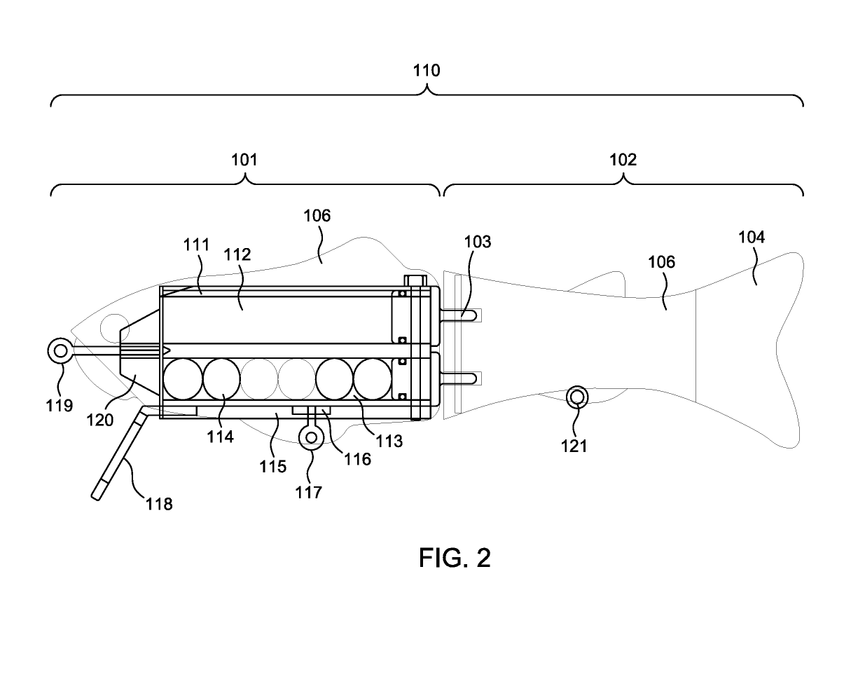

FIG. 2 is a side view with partial cutaway of one embodiment of the field reconfigurable swim bait lure 110 of the present invention. The lure contains an engineered skeletal system 111 featuring an upper buoyancy chamber 112 and a lower buoyancy chamber 113. The upper buoyancy chamber contains air in one embodiment, which provides a buoyancy force which acts to stabilize the lure along the roll axis (to prevent roll-over while being reeled in) and help it float. The upper buoyancy chamber is ⅝″ diameter in one embodiment and may be sized from internal bore diameters of 1/16″ diameter up to 2″ diameter. Alternately, the upper buoyancy chamber may be another shape such as a rectangle or square section or other shape a person practicing the present invention may desire such as an irregular curved shape to fit inside and follow the contours of the outer fish shape of the fishing lure. The overall length of the field reconfigurable swim bait lure is approximately 250 mm in one embodiment and may range from 50 mm to 500 mm in alternate embodiments and may be used for freshwater and saltwater fishing.

The lower buoyancy chamber is preferably configured to receive one or more items of ballast 114 in order to allow for the easy adjustment of the pitch attitude (i.e. nose up, nose down) of the lure as well as to enable the lure to float or sink at a wide variety of different rates of fall (ROF). In one embodiment, the items of ballast are ½ inch spherical balls in a variety of materials, each with different density properties such as lead, stainless steel, tungsten, plastic and the like, although ballast items such as spherical balls may be any size for example from 1/16″ diameter to 1″ diameter. The variety of materials and associated densities of said materials allow a person practicing the present invention to arrive at nearly infinite combinations of swimming attitude, roll stability and ROF.

In other embodiments, the engineered skeletal system may have any number of cavities, passages and chambers configured as buoyancy chambers or ballast chambers or for any other purpose. In one example, an engineered skeletal system may have just one chamber to receive ballast, or the one chamber may be to entrap air for buoyancy. The buoyancy may be precisely altered by the fisherman by adjusting how much air is entrapped in a buoyancy chamber. One way to alter the volume of entrapped air is to displace air by placing items inside the chamber, thereby reducing the remaining volume available for the air to occupy. In the embodiment where there is an upper and lower buoyancy chamber, the upper chamber should predominantly contain air and lightweight displacement objects but not heavy displacement objects such as metal or other types of ballast that are more productively used in the lower chamber. This is to preserve and enhance the roll over resistance of the fishing lure. The ideal design is to have the upper chamber exerting an upwards force such as through the buoyancy of entrapped air, and the lower chamber exerting a downwards force, such as through being filled with ballast and/or flooded with water. Allowing heavy objects in the upper chamber or allowing entrapped air in the lower chamber are counterproductive to the objective of providing roll resistance.

The skeletal system may be made from a variety of plastic materials and with consideration for the respective densities of such plastic materials relative to the density of water, which has a density of 1.0 grams per cubic centimeter (g/cm3). For example, the skeletal system may be made from polypropylene or polyethylene, both which have densities of 0.90-0.96 g/cm3 which would contribute to the fishing lure's propensity to float prior to the addition of user configurable ballast. Conversely, plastics with densities that sink in water such as polycarbonate (1.20 g/cm3) or Delrin/acetal (1.40 g/cm3) may be used, which would contribute to the fishing lure's propensity to sink prior to the addition of user configurable ballast. In one embodiment, the skeleton is made from acrylonitrile butadiene styrene (ABS, which is 1.06-1.08 g/cm3).

In another embodiment, the chamber that receives ballast may be formed as an integral part of the head portion or the tail portion of the fish lure since fishing lures that practice the present invention need not have a dedicated skeletal system. For example, a lure may be made from casting resin or injection molded plastic in the shape of a fish and a hole may be drilled into the resin or formed into the plastic to allow for the placement of one or more items of ballast inside the chamber. When mass production is desirable, the fishing lure may be formed by injection molding the lure in two halves and then assembling the halves together such as by glue, mechanical snaps or fasteners, or by ultrasonic welding, to name a few. In one injection molded embodiment, the buoyancy chamber is formed integrally to the injection molded halves and the user accessible buoyancy chamber is also formed integrally to the molded part or parts, which are one and the same parts that also form the outside shape and aesthetic of the fishing lure.

The buoyancy chamber(s) may be accessed by the end user by partially disassembling the fishing lure to gain access, and such access may be to the front of the lure, the rear of the lure as described herein, the top of the lure or the bottom of the lure. The ballast may be retained externally to the fishing lure such as by being inserted, adjusted or removed from a rail system such as the rail system described herein that, in an exemplary embodiment, protrudes longitudinally from the bottom of the lure.

Another novel feature of the present invention is the rail system 115 that in one embodiment is an integral part of the skeletal system located along the bottom to allow a wide variety of accessories to be slid into place either during the manufacturing process or by a fisherman in the field. The rail system can accommodate features such as a hook plate 116 which is slideably located and provides a strong anchor point for a hook eye 117 to which may be attached any number of fishing hooks or other fishing tackle as may be desired by a person practicing the invention. The body of the fishing lure may be designed to be molded around the rail thereby hiding it from view of the end user, or alternately, the fish body may be shaped to leave the rail system exposed as an additional source of adding, adjusting and removing a wide variety of fishing lure accessories such as rattles, hooks, magnets, lights, electronics devices and additional ballast. In one embodiment, the rail system at least has the front portion remaining exposed and accessible by the end user in order to allow the easy installation and removal of a wake bill 118, containing a male tab, which is slideably received by the front portion of the female rail system. Alternately, the wakebill may have a female attach feature and the rail system may use a male tab to engage the wakebill. The rail system may feature indentations, notches or other features to allow items installed in the rail system to be clicked into place and mechanically retained until the end user desires to adjust or remove the item from the rail system. The wake bill may be formed from any number of materials and processes and in one embodiment is formed from polycarbonate plastic material.

FIG. 2 additionally shows a front eye hook 119, which may be preinstalled into the skeletal system using a feature such as screw boss 120, which locates the eye hook in the proper position during the process of shaping, molding or casting the fish body around the skeletal system during the manufacturing process. In one embodiment, the skeletal system is pre-manufactured and the front hook eye, the hook plate and hook eye are installed in the desired position and the entire skeletal system is then inserted into a fish-shaped mold, where a material is injected or poured over the skeletal system, thereby hiding most of it from the end user except for access to the front of the rail system where the wake bill is inserted and also allowing accessibility by the end user to the rear end of the head portion 101 of the present invention for the purpose of adjusting the ballast while in the field. The external fish-like shape of the fishing lure may be formed from any number of materials and processes and in one embodiment is formed from pouring or injecting casting resin into a mold. The buoyancy of the body of the fishing lure may be altered by the manufacturer of the fishing lure of the present invention such as by the addition of a quantity of glass microspheres, which are tiny hollow glass spheres, into the liquid resin prior to pouring or injecting said resin into a fish-shaped mold. In this way, the buoyancy characteristics of the fishing lure can be predetermined by the manufacturer in order to fall into a range of overall weight, balance, and buoyancy whereby the end user may exercise a desirable range of command over the final lure weight, balance, and buoyancy through the placement and adjustment of items of ballast into the user-accessible ballast tube(s) or rail system. Another way to manufacture the body of the fishing lure may be by injection molding one or more parts in the shape of the fish. In one embodiment, the body of the fishing lure is injection molded in two halves, which are joined together during manufacturing such as my mechanical fasteners, snaps, glue or ultrasonic welding. The injection molded halves may also comprise the geometry of one or more ballast chambers to contain trapped air or ballast. Alternately, the injection molded body of the fishing lure may have a separate skeletal system placed inside or otherwise attached to it during manufacturing. In one embodiment, the body of the fishing lure and the skeletal system are made from different materials.

The present invention features a hinge 103, a tail portion 102, and in some embodiments a casting resin body 106, but the tail 104 of the present invention is configured to allow replacement by the fisherman of the rearmost portion of the tail to include changing the shape, material and performance of the tail in the field to accommodate various fishing conditions and scenarios. A rear hook eye 121 is optionally provided to allow more than one hook to be attached to the bottom of the lure of the present invention.

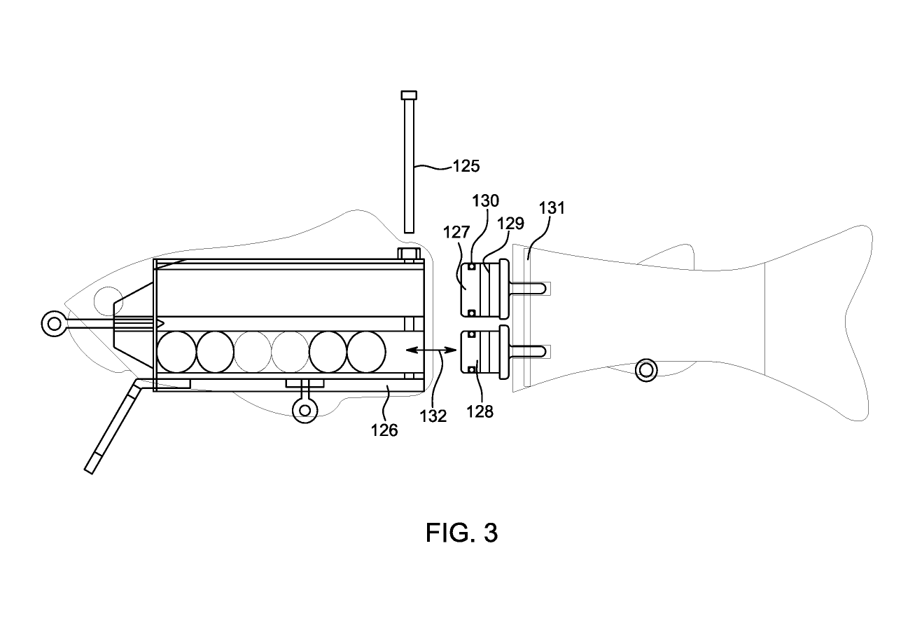

Another advantage of the present invention over the prior art is the accommodation of rapid and easy access to the skeletal system and ballast by a fisherman in the field as shown in FIG. 3. In one embodiment, a takedown pin 125 is provided, which when removed, allows the tail portion to separate from the head portion thereby optionally exposing the upper chamber containing the buoyancy air and at least exposing the chamber containing the ballast, which in one embodiment is the lower chamber. In some embodiments including the embodiment of FIG. 3, the upper chamber is also exposed during the process of separating the tail portion from the head portion to access the ballast.

An airtight seal of the upper and lower chambers is accomplished by an upper plug 127 and a lower plug 128 which provide a seal such as by use of an o-ring 130. In an alternate embodiment, the ballast may be exposed or encapsulated in a non-airtight chamber. The upper and lower plug each contain a bore 129 to allow passage of the takedown pin to locate and retain the plugs in the proper position during fishing. Optionally, the takedown pin may be a screw having a captured nut 126 which may be snapped, restrained or otherwise located in the lower rail system. An arrow 132 shows the direction of separation once the fisherman removes the takedown pin and pulls on the tail portion to separate it from the front portion in order to access and reconfigure the ballast. A hinge pin 131 is provided to enable the tail portion to pivot laterally relative to the head portion by way of the upper and lower plugs which have tabs to receive the hinge pin. The hinge pin may be secured in place by a press fit, or in alternate embodiments by glue, a snap feature or by screw threads. In some embodiments, the hinge is eliminated and the fishing lure is constructed to have a single body.

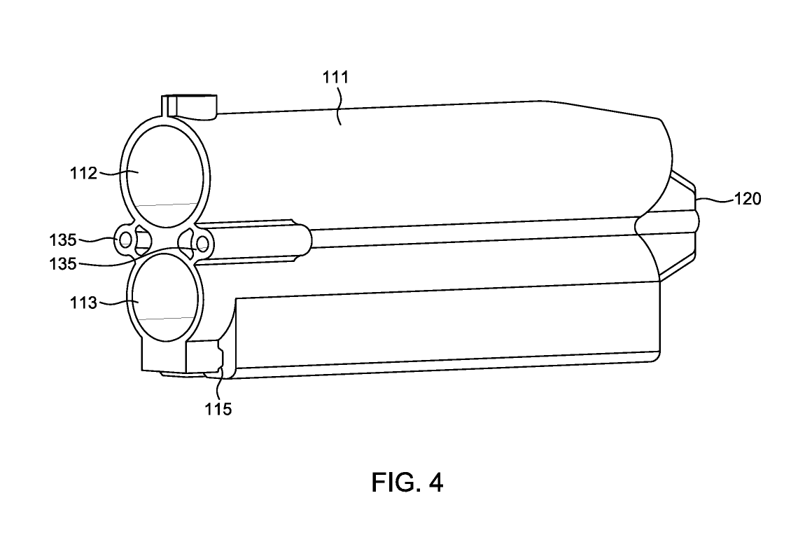

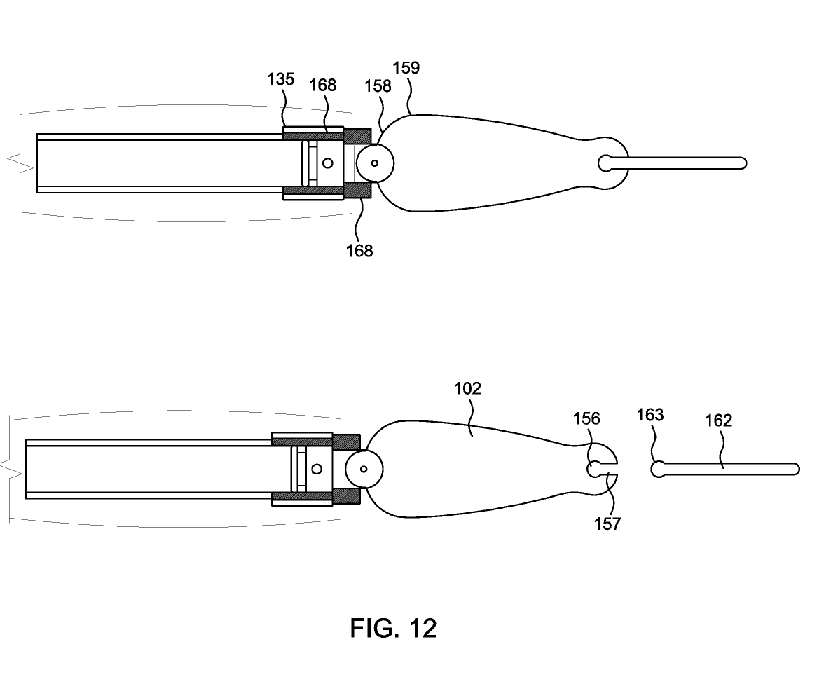

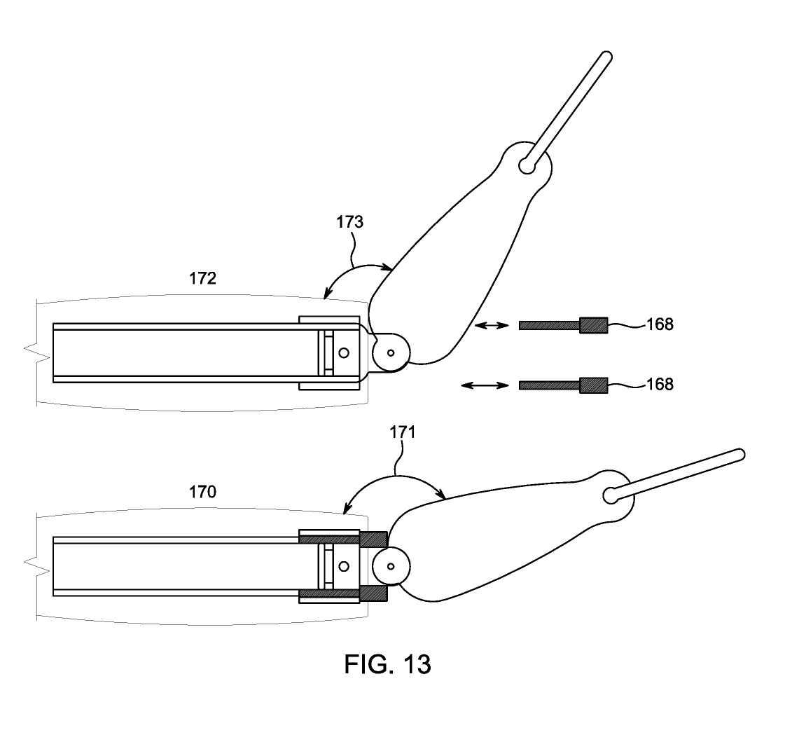

FIG. 4 is a perspective view of the skeletal system 111 showing different views of screw boss 120, upper bore 112, lower bore 113 and rail system 115. In one embodiment, stop pin cylinders 135 are provided to allow the user to customize the tail pivot angle by inserting and removing stop pins of various lengths as shown with more particularity in FIGS. 12 and 13.

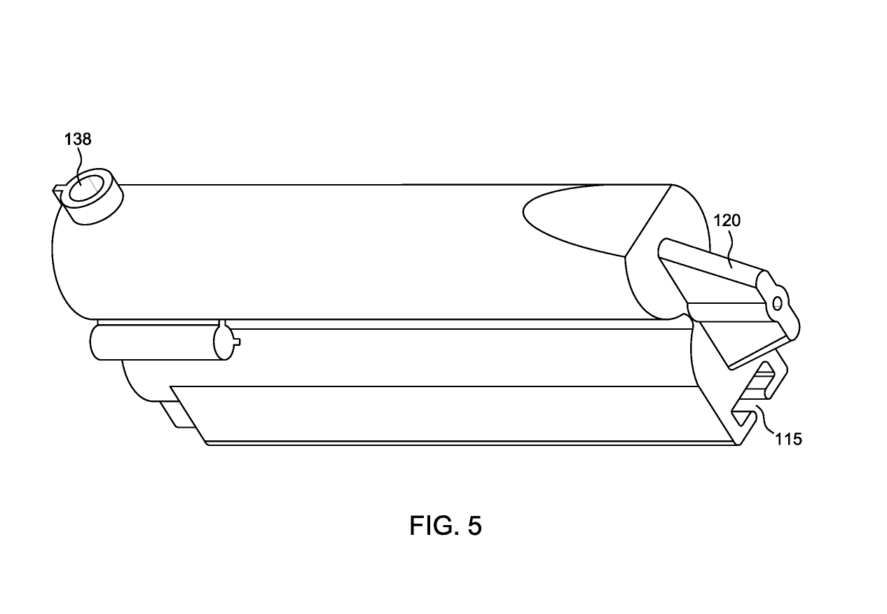

FIG. 5 is another perspective view of the skeletal system showing yet another view of screw boss 120 and rail system 115. This view shows the front portion of the rail system where a user practicing the present invention may have easy access by which to install and remove a wake bill or other accessory into the rail system as may be desirable while fishing. Additionally, a male boss 138 is show on the top of the skeletal system which may be provided to receive and hide the head of the takedown pin or screw.

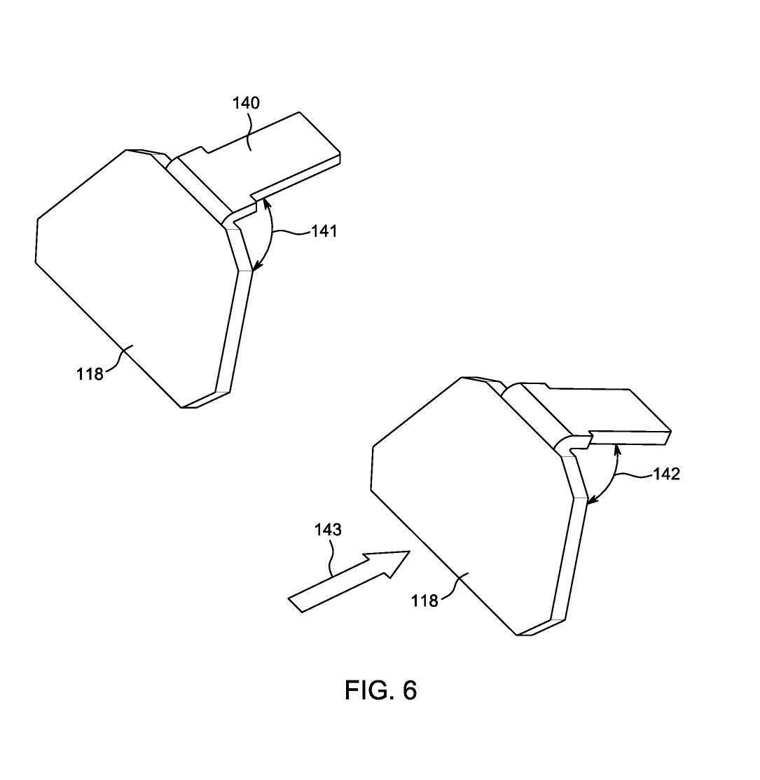

FIG. 6 shows two embodiments of customized and removable wake bills of the present invention. The wake bills feature a rail tab 140 protruding from the body of the wake bill at various angles such as first wake bill angle 141 and second wake bill angle 142. In exemplary embodiments, first wake bill angle may be 60 degrees and second wake bill angle may be 90 degrees. In alternate embodiments, the wakebill angle may be 10 degrees up to 170 degrees. The interchangeability of the wake bills of the present invention allows a person practicing the invention to customize the swimming, waking and diving performance of the fishing lure through an infinite combination of wake bill size, shape and tab angles which each cause the lure to react differently when in contact with onrushing water pressure as shown by water pressure arrow 143.

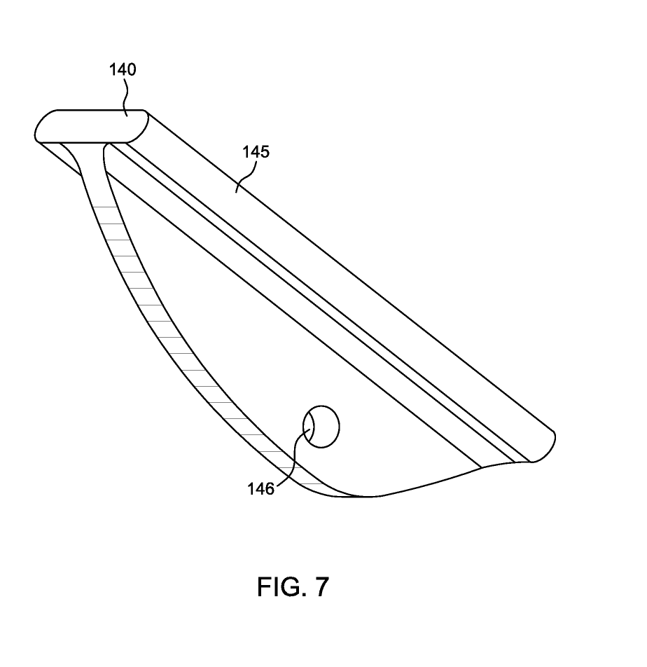

FIG. 7 shows an optional hook attach fin 145 which may be slideably installed in the lower rail system in place of, or in addition to, the hook plate 116 and hook eye 117 in order to provide a strong attach point for a fishing hook on the underside of the lure. The hook attach fin has a rail tab 140 to matably and slideably engage the lower rail system and may include a hole 146 to receive a fishing hook and in one embodiment, features a fin-shaped profile that adds visual enhancement and realism to the fishing lure of the present invention.

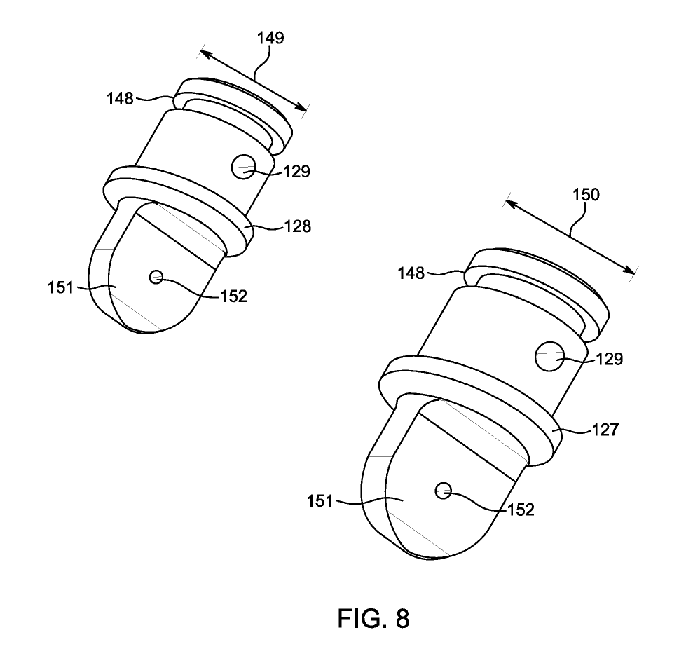

The upper and lower plugs of FIG. 3 are shown in more particularity in FIG. 8. The plugs may be any shape and size that a person practicing the present invention may desire and may feature an o-ring groove 148 to facilitate the airtight seal between the plugs and the upper and lower chambers of the skeleton system. In one embodiment, the upper plug 127 has a first diameter 150 and the lower plug 128 has a second diameter 149. In one embodiment the first diameter is ⅝″ and the second diameter is ½″. In alternate embodiments, the diameter of the upper and lower plugs can range from 1/16″ diameter up to 2″ diameter. Both upper and lower plugs feature a bore 129 to receive the takedown pin and both feature a hinge tab 151 containing a hinge pin bore 152 through which the hinge pin passes to provide the lateral pivoting mechanism between the head portion and the tail portion of the fishing lure.

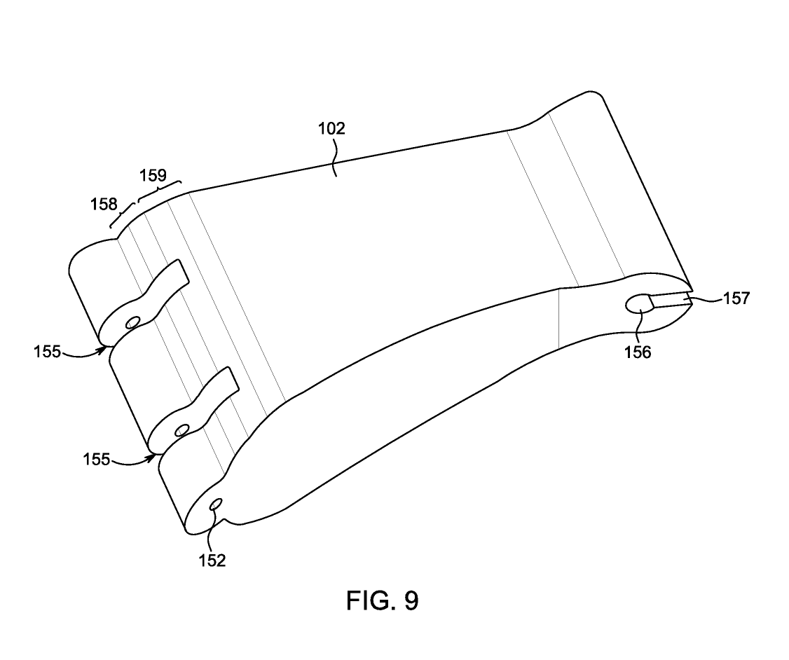

FIG. 9 shows a perspective view of the tail portion 102 of the present invention. The tail portion features hinge grooves 155 to receive the hinge tabs of the upper and lower plugs as well as a hinge pin bore 152 to allow the hinge pin to pass through the tail portion and hinge tab portions of the upper and lower plugs. A tail groove 156 and tail channel 157 provide a retention mechanism by which the user may change out the tail of the fishing lure to accommodate customized swimming performance for various fishing scenarios that may be encountered by a person practicing the present invention. The tail portion may include a first pivot angle 158 and a second pivot angle 159 as part of the mechanism that a fisherman can use to adjust the lateral pivoting of the head portion relative to the tail portion as will be describer further in FIGS. 12 and 13. In alternate embodiments, the tail may be constructed of rigid or flexible materials comprising one or more tail elements.

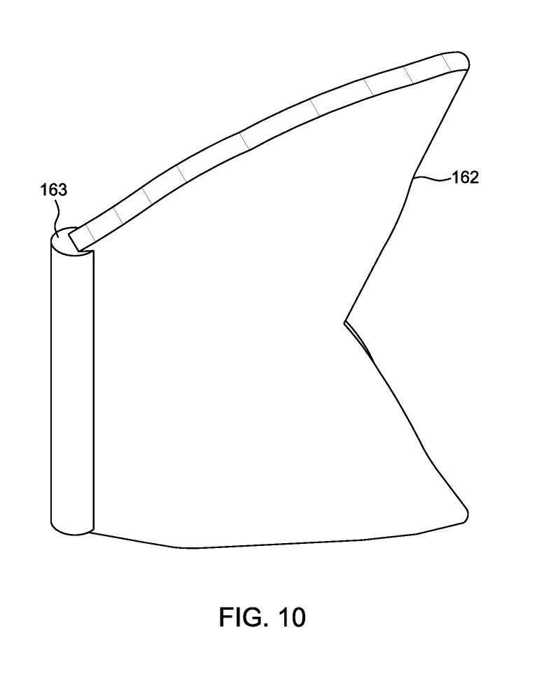

FIG. 10 is a perspective view of a non-shudder tail 162 having a tail boss 163 that is slideably engaged by the tail groove and channel of the tail portion of FIG. 9 to provide a customizable and removable tail by which the fisherman may customize the swimming performance of the fishing lure of the present invention. The shape and material selection of the non-shudder tail has an effect on the swimming performance of the fishing lure. The non-shudder tail may be sized from small to large relative to the front portion of the fishing lure in order to create a desirable aesthetic as well as to alter the swimming performance—for example, a large rigid non-shuddering tail causes the fishing lure to swim with a large lateral amplitude of back and forth motion, while a small and flexible non-shuddering tail causes the fishing lure to swim with a smaller amplitude of back and forth motion and at a higher frequency. Examples of rigid materials for the non-shudder tail include polycarbonate, acrylic, casting resin, polyurethane and other commonly used plastic materials. Examples of flexible materials for the non-shudder tail include silicone, polyvinyl chloride, flexible casting resins, and other commonly used flexible plastic materials including rubbers.

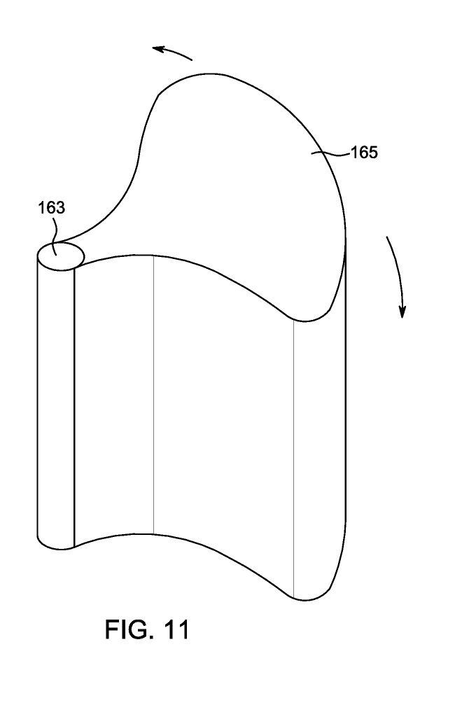

FIG. 11 is a perspective view of a shudder tail 165 of the present invention having a tail boss 163 to allow an end user to easily install the shudder tail in place of a non-shudder tail to alter the swimming characteristics of the fishing lure of the present invention. The shape and material selection of the shudder tail has an effect on the swimming performance of the fishing lure. The shudder tail may be sized from small to large relative to the front portion of the fishing lure in order to create a desirable aesthetic as well as to alter the swimming performance—for example, a large rigid shudder tail causes the fishing lure to swim with a large lateral amplitude of back and forth motion, while a small and flexible shudder tail causes the fishing lure to swim with a smaller amplitude of back and forth motion and at a higher frequency. Examples of rigid materials for the shudder tail include polycarbonate, acrylic, casting resin, polyurethane and other commonly used plastic materials. Examples of flexible materials for the shudder tail include silicone, polyvinyl chloride, flexible casting resins, and other commonly used flexible plastic materials including rubbers. The reduced thickness of the tail near where the tail boss 163 is formed allows the shudder tail the lateral flexibility to perform a stable side-to-side movement, and the larger rear portion of the shudder tail creates a wake vortex that simulates the accurate swimming of a fish. In alternate embodiments, the shudder tail is rigid and the vortex caused by water flowing around the bulbous shape of the shudder tail causes the rear of the fishing lure to pivot about the hinge relative to the front.

FIG. 12 is a series of two views of part of the head portion and the complete tail portion to show the ease by which the non-shudder tail 162, for example, may be installed and removed by the end user via the retention mechanism consisting of tail boss 163 which slideably and matably engages the tail groove 156 of tail portion 102. Also shown in more detail is the first pivot angle 158 and second pivot angle 159 of tail portion that enable a user to customize the lateral pivot motion of the tail portion relative to the head portion as may be required during fishing. In an exemplary embodiment, stop pins 168 may be provided to the fisherman and when installed into stop pin cylinders 135, protrude towards tail portion and contact first pivot angle 158. Stop pin cylinders 135 may be seen with more particularity in FIG. 4 and in one embodiment are located on each side of the skeletal system in a position where stop pins inserted into their bores are located to restrain the lateral pivoting motion of the tail portion. In embodiments where the skeletal system is not used, the function of the stop pin cylinders may easily be accomplished by molding, drilling or otherwise forming features to receive stop pins or their equivalent into the front portion of the fishing lure. In still other embodiments, the stop pin functionality may be formed and exist primarily in the tail portion of the fishing lure.

FIG. 13 provides additional description of the pivot mechanism in view 170 where the stop pins are installed, and limit the pivot angle of the tail portion to a first tail pivot angle 171. View 172 shows the stop pins 168 after removal from stop pin bores by a person practicing the present invention allowing the tail portion to pivot to a greater degree resulting in second tail pivot angle 173. In one embodiment, the first tail pivot angle may be 30 degrees and the second tail pivot angle may be 60 degrees. In alternate embodiments, the range of the tail pivot angle may be from 90 degrees to 179 degrees on each side of the centerline of the fishing lure. In other words, if a tail pivot angle of 90 degrees per side is allowed, then the total range of the tail as it swings from one lateral extent to the other would total 180 degrees of motion. Conversely, if a tail pivot angle of 179 degrees per side is allowed, then the total range of the tail as it swings from one lateral extent to the other would be 2 degrees.

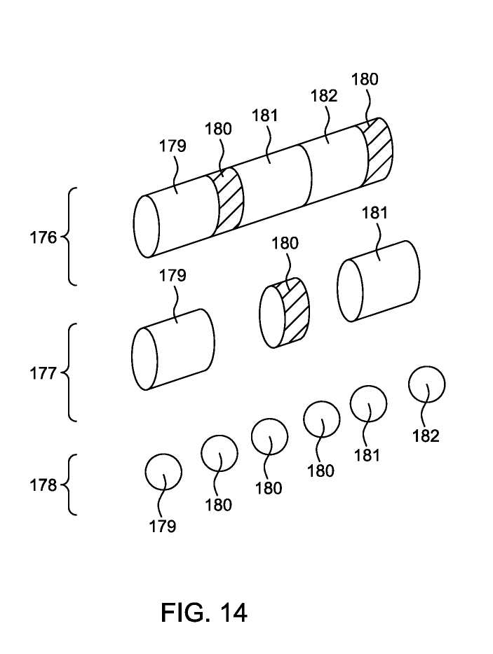

FIG. 14 is a perspective view of exemplary types of ballast including a ballast cartridge 176, a multi-piece series of ballast cylinders 177 and a series of ballast balls 178. The ballast cartridge may be made from one or more materials having one or more densities and may be provided to the end user in an easy-to-install one-piece cartridge having a generally cylindrical shape. A number of such ballast cartridges may be provided to the end user, that are pre-engineered to result in desirable pitch attitudes, swimming profiles or ROF characteristics. An exemplary ballast cartridge may be comprised of various internal quantities of materials such as plastic 179, lead 180, stainless steel 181 and hollow air filled 182.

The ballast cylinders may be provided to the end user in different shapes, sizes and materials, each having associated ballast properties useful to the fisherman for controlling and customizing the pitch attitude, swimming profiles or ROF characteristics of the fishing lure of the present invention. Ballast cartridges may be generally cylindrical in such materials as plastic 179, lead 180, and stainless steel 181.

Ballast balls may be spherically shaped and provided in commercially available diameters and in such materials as plastic 179, lead 180, stainless steel 181 and hollow air filled 182. The end user may arrange a series of balls in different orders and combinations inside the lower buoyancy chamber in order to control and customize the pitch attitude, swimming profiles or ROF characteristics of the fishing lure of the present invention.

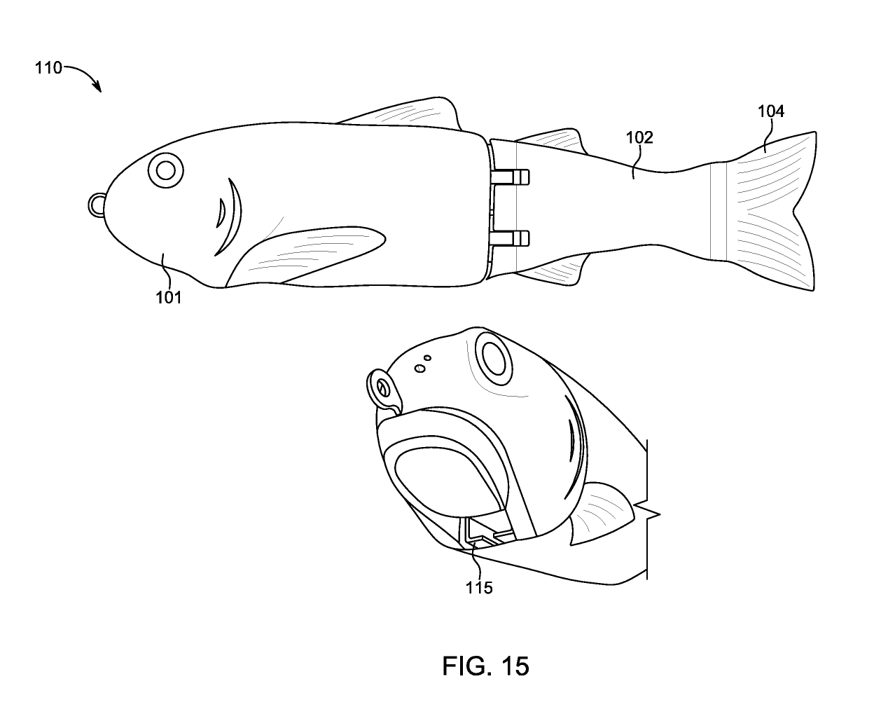

FIG. 15 is an assembly view of a working prototype of the field reconfigurable fishing lure 110 of the present invention showing the head portion 101, tail portion 102 and tail 104. The optionally partially concealed lower rail system 115 can be seen from the front of the lure to enable the end user to insert a rail accessory such as a wakebill into the rail while the remaining portion of the rail system is hidden from view by being covered by the material that forms the outer fish-like shape of the fishing lure.

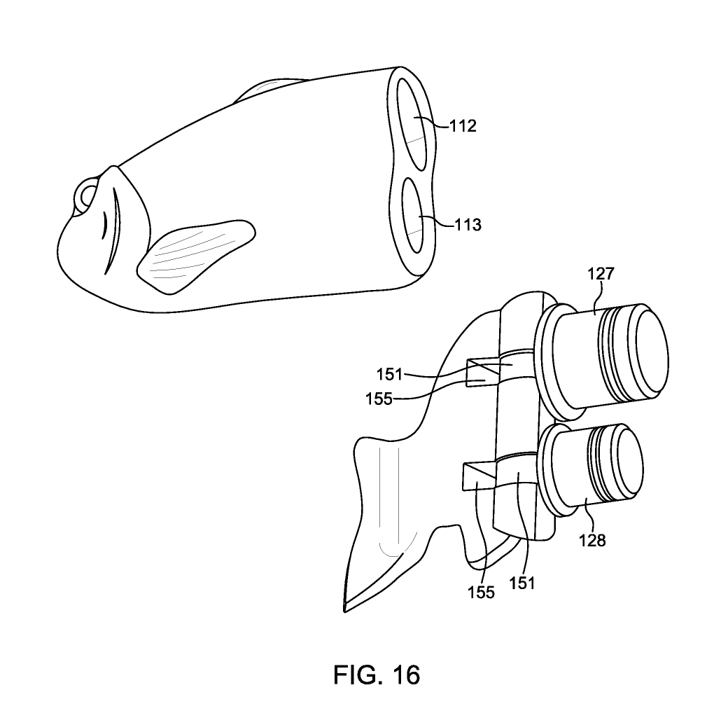

FIG. 16 is a perspective view of a working prototype of the fishing lure of the present invention showing the field disassembly of the head and tail portions to reveal upper buoyancy chamber 112, lower buoyancy chamber 113 as well as the upper plug 127, lower plug 128 and the hinge mechanism comprising hinge tabs 151 and hinge grooves 155.

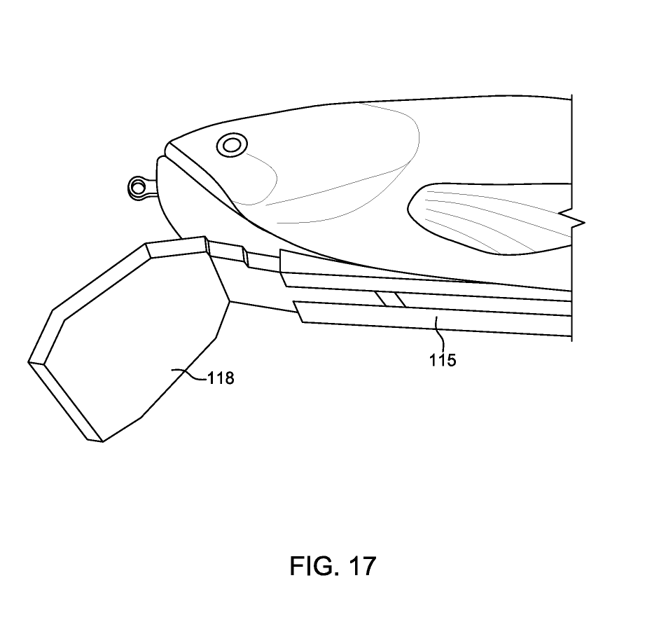

FIG. 17 is a perspective view of the underside of a working prototype of the fishing lure of the present invention showing the optionally exposed lower rail system 115 with an end user installed wake bill 118. In an exemplary embodiment, the rail system 115 remains exposed or partially exposed along the bottom of the fishing lure to enable an end user to install, reposition and remove various rail accessories and previously enumerated.

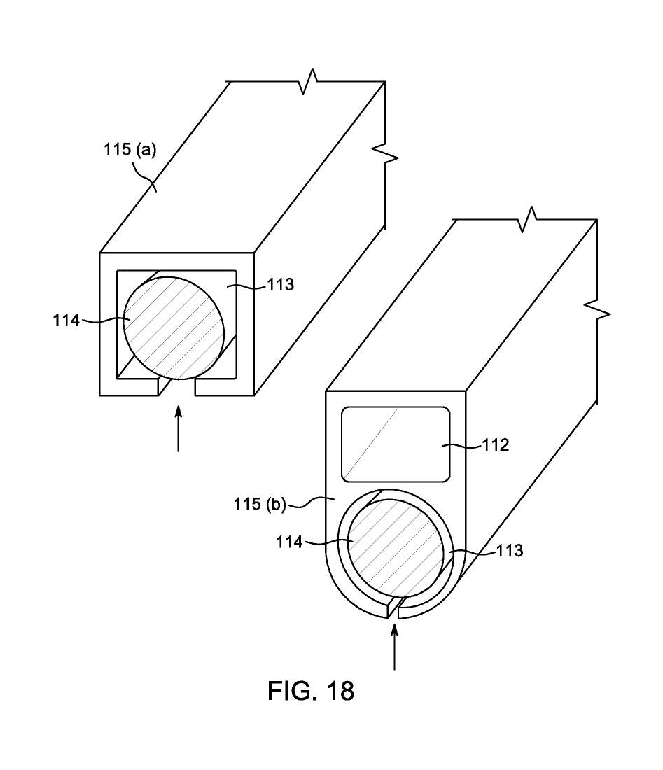

FIG. 18 is a perspective view of two alternate embodiments of the lower rail system, rail system 115(a) and 115(b). Rail system 115(a) shows an alternate embodiment to the rail system that incorporates the functionality of the lower buoyancy chamber of the skeletal system into the rail system. The open groove in the rail system 115(a) indicated by the arrow allows water to flood into the area containing the ballast 114. In some embodiments, such flooding of the ballast chamber is desirable, especially when using spherically shaped ballast. The air pockets that exist when one or more spheres are inserted into a cylinder create small pockets of buoyancy, which when located low on the fishing lure such as in the lower buoyancy chamber, have an undesirable effect of reducing the roll resistance of the fishing bait because the low trapped air exerts an upwards force, inviting rollover tendencies. Similarly, rail system 115(b) has a groove indicated by the arrow, through which water may flow to flood the lower ballast chamber 113 to remove unwanted air pockets. In alternate embodiments, such flooding can be enabled by holes in any side of the lower ballast chamber including the end caps. Rail system 115(b) shows an alternate embodiment upper buoyancy chamber 112 that could be sealed to contain air for maintaining the buoyancy and roll resistance of the fishing lure. Rail systems 115(a) and 115(b) are alternate embodiments to the skeletal system previously described that enable similar functionality and user customization through various combinations of the novel elements of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A field reconfigurable fishing lure comprising:
a head portion;
a tail portion;
at least one cavity accessible by an end user to receive ballast;
whereby the buoyancy of the fishing lure is adjustable based on the insertion or removal of the ballast by the end user.

2. The fishing lure of claim 1, wherein the at least one cavity is internal to the head portion.

3. The fishing lure of claim 1, wherein the ballast is comprised of a plurality of items.

4. The fishing lure of claim 3, wherein the ballast is comprised of a plurality of materials.

5. The fishing lure of claim 4, wherein at least one of the ballast materials is a metal.

6. The fishing lure of claim 4, wherein at least one of the ballast materials is a plastic.

7. The fishing lure of claim 4, wherein at least one of the ballast materials is a resin.

8. The fishing lure of claim 1, wherein the ballast is at least one cylinder.

9. The fishing lure of claim 1, wherein the ballast is at least one sphere.

10. The fishing lure of claim 1, wherein the tail portion pivots relative to the head portion.

11. The fishing lure of claim 10, wherein the pivot angle of the tail portion is adjustable by the end user.

12. The fishing lure of claim 1, whereby the rate of fall of the fishing lure is adjustable based on the insertion or removal of the ballast by the end user.

13. A fishing lure of claim 1, whereby the pitch attitude of the fishing lure is adjustable based on the insertion or removal of the ballast by the end user.

14. A field reconfigurable fishing lure comprising:
a head portion;
a tail portion;
a hinge connecting the head portion to the tail portion;
means for altering the pivot angle of the hinge by the end user.

15. A field reconfigurable fishing lure comprising:
a head portion;
a tail portion;
a rail system accessible by an end user to receive ballast;
whereby the buoyancy of the fishing lure is adjustable based on the insertion or removal of the ballast by the end user.
